(19) United States
(12) Patent Application Publication
(10) Pub. No.: US 2005/0060902 A1
(43) Pub. Date: Mar. 24, 2005

(54) Saddle square for marking stud locations

(76) Inventor: Steven K. Jones, Ottawa (CA)

Correspondence Address: JOHN S. PRATT;KILPATRICK STOCKTON LLP (LEE VALLEY TOOLS LTD.), 1100 PEACHTREE STREET, SUITE 2800, ATLANTA, GA, 30309, US

(21) Appl. No.: 10/914,588

(22) Filed: Aug. 9, 2004

Related U.S. Application Data
(60) Provisional application No. 60/494,311, filed on Aug. 11, 2003.

(51) Int. Cl. B43L 7/027

(52) U.S. Cl. 33/474

(57) ABSTRACT

A saddle square including a slot for aligning the square and marking a workpiece to ensure proper positioning of a stud.

### CROSS-REFERENCE TO RELATED APPLICATIONS

This application claims priority to U.S. Provisional Patent Application Ser. No. 60/494,311 filed Aug. 11, 2003 entitled “Saddle Square For Marking Stud Locations,” which is incorporated herein by reference.

### FIELD OF THE INVENTION

This invention relates to marking tools generally used and, in particular, to saddle squares used in carpentry woodworking.

### BACKGROUND

During construction of a typical wood frame stud wall, the locations of the studs must be marked on the top and bottom plates so that studs can be properly located. Typically, the studs are placed at a consistent center-to-center distance, usually sixteen or twenty-four inches. The builder generally will place marks along the top and bottom plates that mark the centers of the studs. However, to correctly align the studs, a mark half the thickness of the stud material away from the center mark is also desirable.

### BRIEF DESCRIPTION OF THE DRAWINGS

FIG. 1 is a perspective view of the saddle square of this invention positioned on a “2×4” lumber workpiece.

FIG. 2 is an end view of the saddle square shown in FIG. 1.

FIG. 3 is a plan view of the saddle square shown in FIG. 1.

### SUMMARY

One embodiment of an improved saddle square of the invention includes a body having one longer arm that lies against an edge of a lumber workpiece and one shorter arm that lies against a face of the workpiece. The longer arm is penetrated by a slot, which is adapted to receive a marking instrument. The width of the saddle square is approximately equal to the width of standard 2× lumber, so that when the slot is positioned over a stud centering mark on the workpiece, the edges of the square fall on the workpiece at the appropriate locations for the edges of the stud. The stud edge locations may then be marked so that the stud may be easily correctly aligned.

It is therefore a feature of this invention to provide a saddle square for easily and accurately aligning a stud.

### DETAILED DESCRIPTION

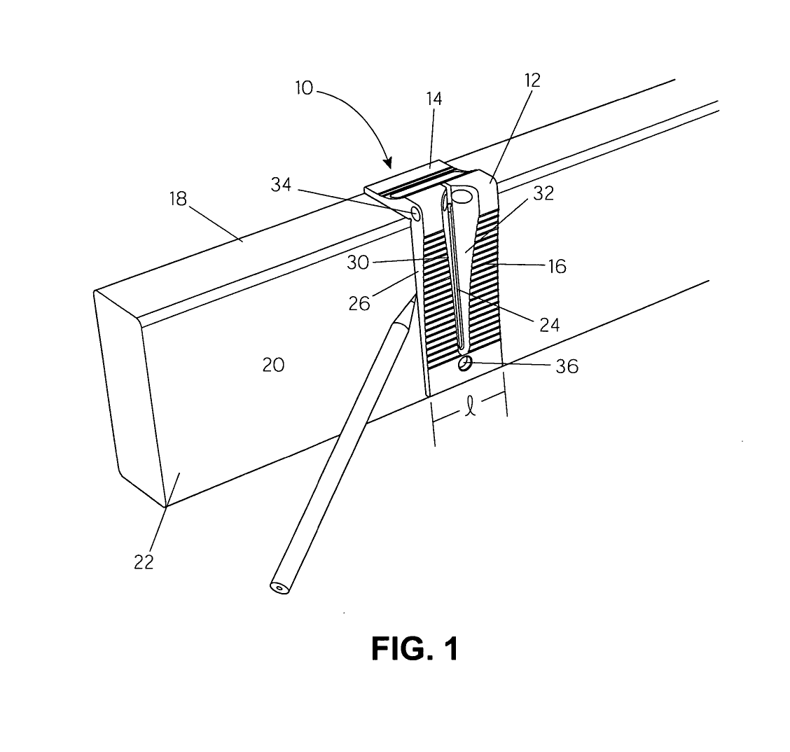

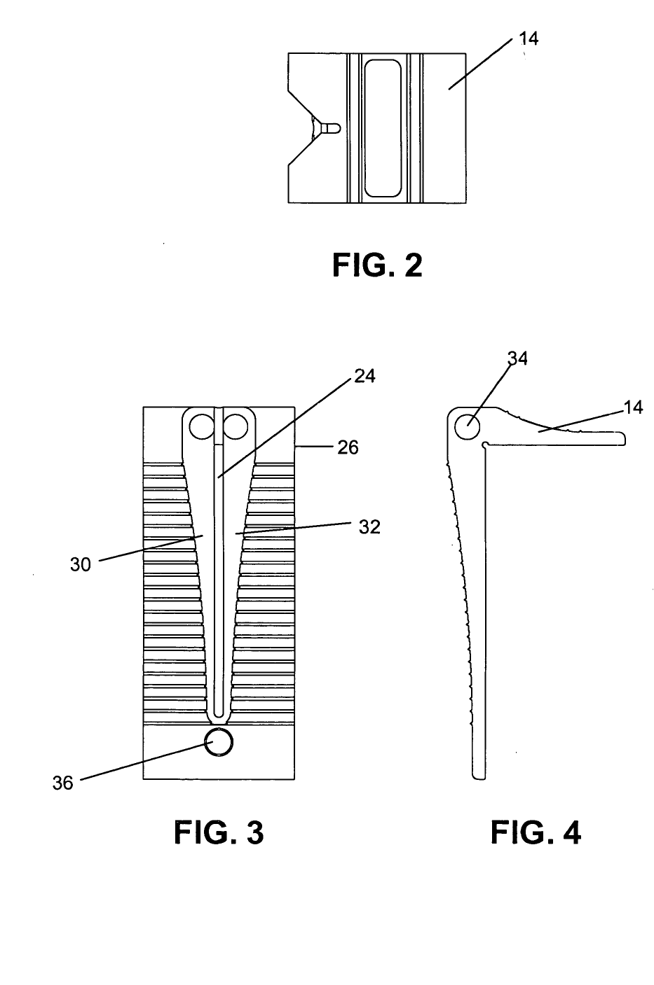

As may be seen by reference to FIG. 1, the saddle square 10 of this invention includes generally a body 12 having a shorter arm 14 and a longer arm 16 that, during use, lie against one edge 19 and one face 20, respectively of a “2×4” or other size lumber workpiece 22. Arm 16 of saddle square 10 is penetrated by a narrow, centrally located slot 24. The width of saddle square 10 is equal to the width of standard “2×” lumber, i.e., approximately 1½ inches. In use, slot 24 is positioned over a stud centering mark on the workpiece 22. Since the width of the saddle square is equal to the thickness of typical stud material, the edges of the saddle square 10 fall on the workpiece 22 at the appropriate locations for the edges of the stud to be positioned on that workpiece 22. These stud edge locations can be marked by scribing against the edges (e.g., edge 26) of saddle square 10 with a pencil 21 or other marking instrument such as a marking knife or awl. The length (l) of the saddle square 10, is the thickness of typical stud material, so that the user is able quickly to create alignment marks on the stud 22 by marking on either side of the saddle square 10. A typical stud thickness may be 1½ inches, so that length (l) is also 1½ inches. Edges 26 of saddle square 10 are precisely machined perpendicular to the reference faces (that are not visible since those faces lie against the workpiece 22) so that marks made by reference to the edges 26 are positioned square to adjacent faces of the workpiece 22 as well as at the appropriate separation from each other. As a result, the marks are ideally suited to align stud 22 correctly. In an alternative embodiment, one or both edges of the square may be aligned with at least one mark on the workpiece, and an additional mark added by sliding the marking instrument within the slot while contacting the workpiece.

Saddle square 10 may be made from extruded aluminum having the cross sectional shape depicted in the figures or any other appropriate shape with two faces square to each other. The slot 24 and the entrance thereto having faces 30 and 32 forming a VEE-shaped throat leading to slot 24 can be conventionally machined in the saddle square body 12. The hole 34 along the length of the saddle square 10 is used for hanging the square 10 during anodizing. A hard anodized finish is desirable for a square 10 manufactured of aluminum. Hole 36 is used for hanging during storage, and may also be sued for hanging the square during anodizing. Other suitable materials than aluminum can also be used, including metals such as brass or steel and a variety of molded or machined polymer molded materials such as glass filled nylon, or any other relatively hard, stable, wear-resistant material.

As will be appreciated by those skilled in the art, this invention can be practiced in numerous alternative embodiments in addition to those shown in the drawings and described above without departing from the spirit of this invention or the scope of the following claims.

1. A saddle square, comprising a body having first and second arms that contact a workpiece, the second arm comprising a slot.

2. The saddle square of claim 1, wherein the slot is centrally located on the second arm.

3. The saddle square of claim 1, wherein the saddle square is manufactured from a length of extruded aluminum profile.

4. The saddle square of claim 1, wherein a width of the saddle square is 1½ inches.

5. The saddle square of claim 1, wherein the slot is sized to receive a marking instrument for marking a workpiece against which the square is positioned by sliding the marking instrument within the slot while contacting the workpiece.

6. The saddle square of claim 1, each arm further comprising a reference face for contacting the workpiece.

7. The saddle square of claim 1, further comprising edges machined perpendicular to the reference faces.

8. The saddle square of claim 3, further comprising a hard anodized finish.

9. A saddle square manufactured from a length of extruded aluminum profile and comprising a slot.

10. A saddle square, comprising a body having first and second arms that contact a workpiece, the second arm comprising an opening sized to allow a user to see centering marks on the workpiece.
